(19) United States
(12) Patent Application Publication
(10) Pub. No.: US 2007/0084062 A1
(43) Pub. Date: Apr. 19, 2007

(54) Trimmer

(75) Inventors: Jorg Elfner, Waiblingen (DE); Georg Maier, Kernen (DE); Marc Mildner, Weinstadt-Beutelsbach (DE)

Correspondence Address: ROBERT W. BECKER & ASSOCIATES, Suite B, 707 Highway 66 East, Tijeras, NM, 87059, US

(73) Assignee: Andreas Stihl AG & Co. KG, Waiblingen (DE)

(21) Appl. No.: 11/544,383

(22) Filed: Oct. 6, 2006

(30) Foreign Application Priority Data
Oct. 18, 2005 (DE) 10 2005 049 767.5

(51) Int. Cl. B26B 29/00

(52) U.S. Cl. 30/276; 30/286

(57) ABSTRACT

A trimmer comprising a cutting filament head adapted to be rotatably driven by a drive motor. A cutting filament extends out of the cutting filament head and defines a path during a trimming operation. A guard is provided, and in a trimming position of the trimmer a portion of the guard is disposed between the path of the cutting filament and the ground.

The instant application should be granted the priority date of Oct. 18, 2005 the filing date of the corresponding German patent application 10 2005 049 767.5.

### BACKGROUND OF THE INVENTION

The present invention relates to a trimmer or brushcutter.

U.S. Pat. No. 5,060,383 discloses a cutter having a cutting head, the cutting line of which defines a cutting circle. Disposed above the cutting circle is a guard that essentially extends between the cutting head and the operator. The cutter has a guide portion that extends to part of the periphery of the cutting circle.

It is an object of the present invention to provide an improved guard for a trimmer of the aforementioned general type.

### BRIEF DESCRIPTION OF THE DRAWINGS

This object, and other objects and advantages of the present invention, will appear more clearly from the following specification in conjunction with the accompanying schematic drawings, in which:

FIG. 1 is an illustration of an operator with a trimmer;

FIGS. 2 & 3 are perspective illustrations of the tool end of the trimmer of FIG. 1;

FIG. 4 is a cross-sectional view of one embodiment of a device for cutting a cutting filament to length;

FIG. 5 is a cross-sectional view of another embodiment of a device for cutting a cutting filament to length;

FIGS. 6 & 7 show modified embodiments of the tool end of the trimmer; and

FIG. 8 is a perspective view of the tool end of one embodiment of a trimmer of the present application.

### SUMMARY OF THE INVENTION

The trimmer of the present application comprises a cutting filament head, which is adapted to be rotatably driven by a drive motor, and a guard, wherein a cutting filament extends out of the cutting filament head, wherein during a trimming operation the cutting filament defines a path, and wherein in a trimming position of the trimmer a portion of the guard is disposed between the path and the ground.

As a consequence of disposing a portion of the guard between the path of the cutting filament and the ground, it is possible to largely avoid contact of the cutting filament with the ground. At the same time, it has been shown that the cutting efficiency of the trimmer is not significantly affected by disposing a portion of the guard below the path of the cutting filament, as long as a slight projection of the cutting filament beyond a portion of the guard is maintained. This results from the high speed of the cutting filament. As the trimmer is moved back and forth during operation, only an outer portion of the cutting filament is engaged in the cutting operation. Disposing a portion of the guard in a central or inner region of the path does not adversely affect the cutting process.

A large area of the path is preferably covered by the guard relative to the ground. As a result, the effectiveness of the guard can be considerably improved. The portion of the guard that during operation is disposed between the path of the cutting filament and the ground is in particular embodied as a base plate. The base plate is preferably planar or is slightly bulged. This results in an economic straightforward configuration. The base plate preferably has a central opening through which the cutting filament head extends. The cutting filament head is expediently provided with an actuating device that effects a post feeding of cutting filament, whereby the actuating device extends through the central opening of the base plate. Such actuating devices are known. When the actuating device bumps against the ground, the cutting filament is post fed. In so doing, the cutting filament can come into contact with the ground and can stir up the dirt and damage plants. This is prevented by the guard, which is embodied as a base plate. However, the base plate could also be flexible and can act upon an actuating device, whereupon the actuating device effects a post feeding of cutting filament. A straightforward configuration results if the base plate is mounted so as to be rotatable relative to the cutting filament head. In this connection, the base plate can be mounted on the cutting filament head or on the drive shaft. Due to the fact that the base plate is mounted so as to be rotatable, it comes to a stop when it contacts an obstacle, for example the ground, thereby preventing a stirring up of earth or damage to plants. In this way, an expensive, fixed support of the base plate can be avoided.

A portion of the guard is preferably disposed on that side of the path of the cutting filament that during operation is remote from the ground. The portion of the guard that during operation is disposed on that side of the path remote from the ground is, in this connection, in particular embodied as an upper cover plate.

The trimmer may have a housing, in which a drive motor is disposed, and a guide tube, whereby the cutting filament head is disposed at that end of the guide tube that is remote from the housing. In this connection, the base plate is in particular disposed on that side of the path that faces away from the guide tube, and the upper cover plate is preferably supported on the guide tube or on the gear case of the trimmer. In order to also limit the engagement range of the cutting filament along the periphery, the guard may be provided with a peripheral wall that covers a portion of the periphery of the path of the cutting filament. A straightforward structural configuration results if the peripheral wall connects the base plate with the upper cover plate. The peripheral wall, the base plate and the upper cover plate in this connection in particular form a largely closed housing that permits contact of the cutting filament with the material that is to be cut only in a prescribed range. The guard preferably has an open area along the periphery at which the path of the cutting filament is not covered by the guard. A good cutting efficiency, along with good protection of the cutting filament, results if in the open area of the guard the filament projects out by more than 5 mm and less than 25 mm, in particular approximately 10 mm, beyond the guard. The open area preferably extends over an angle a of at least 180°, in particular approximately 270°. In order to achieve a uniform cutting depth, the trimmer may be provided with a device for cutting the filament to length, whereby such a device is in particular disposed on the inner side of the guard. This results in a straightforward, compact configuration of the trimmer. The device for cutting the filament to length preferably connects the base plate with the upper cover plate. As a result, further connection elements or a peripheral wall between base plate and an upper cover plate can be eliminated.

Further specific features of the present application will be described in detail subsequently.

### DESCRIPTION OF SPECIFIC EMBODIMENTS

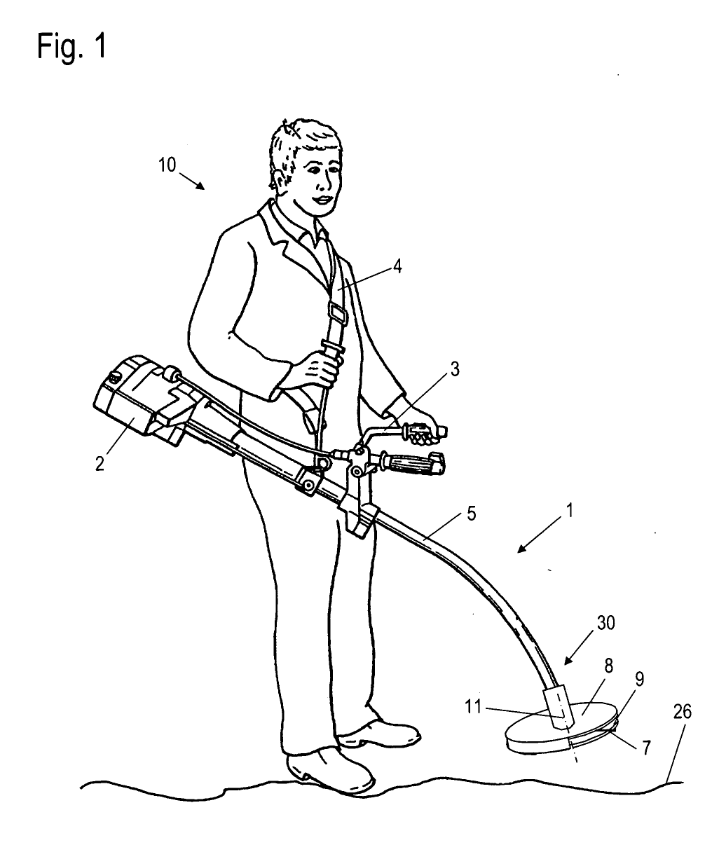

Referring now to the drawings in detail, the trimmer or brushcutter 1 shown in FIG. 1 has a housing 2 for a drive motor, especially an internal combustion engine, and preferably a two-cycle motor. Secured to the housing 2 is a guide tube 5 on which is disposed a cutting control handle 3 and a carrying strap 4, which is placed over the shoulder of an operator 10. The tool end 30 of the trimmer 1 is moved back and forth over the ground 26 by means of the cutting control handle 3. The tool end 30 of the trimmer 1 is disposed on that end of the guide tube 5 that is remote from the housing 2. Secured to the guide tube 5 is a guard 8 in which a cutting filament 7 rotates about an axis of rotation 11. The guard 8 has an open area 9 where the cutting filament 7 extends out of the guard and can come into engagement with plants that are to be mowed or cut. The open area 9 extends along the periphery of the guard 8 and has a somewhat slot-shaped configuration.

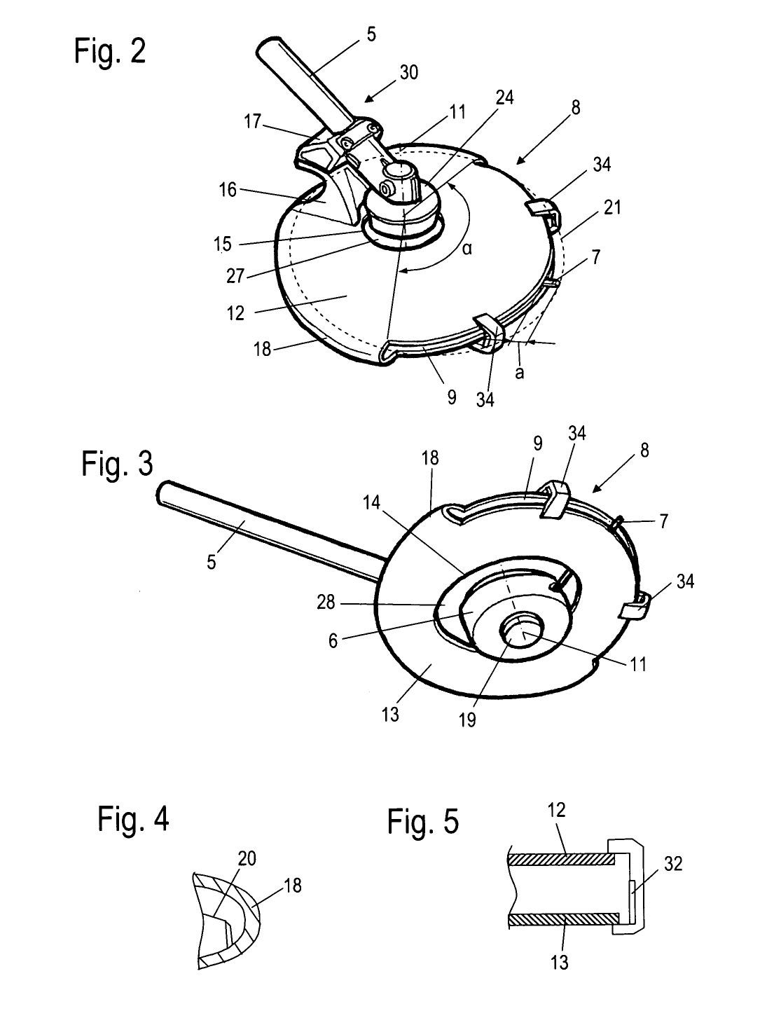

As shown in FIG. 2, a mounting bracket 17 is supported on the guide tube 5 at the tool end 30 thereof. A holder or fastener 16, to which the guard 8 is secured, is fixed to the mounting bracket 17. Disposed on the guide tube 5 is a housing 24 in which is mounted a cutting filament head 6, which is shown in FIG. 3. The cutting filament head 6 is mounted in such a way as to be rotatable about the axis of rotation 11, and is driven by the drive motor in the housing 2 so as to rotate about the axis of rotation 11. The cutting filament 7 extends out of the cutting filament head 6. Upon rotation about the axis of rotation 11, the cutting filament 7 defines the path 21, which is shown in FIG. 2 and forms a planar cut.

The guard 8 has an upper cover plate 12, which essentially covers the path 21 on that side of the path that faces the guide tube 5 and that during operation faces away from the ground 26. In this connection, the upper cover plate 12 is disposed approximately parallel to the plane of the path 21 and perpendicular to the axis of rotation 11. The upper cover plate 12 has a central opening 15, through which the housing 24 extends. Formed between the opening 15 and the housing 24 is an annular gap 27. Due to the annular gap 27, and as a consequence of the centrifugal effect of the cutting filament 7, a blower effect results that serves to keep the working region free. However, the upper cover plate 12 can also extend up to the housing 24, and in particular can be secured there.

As shown in FIG. 3, the guard 8 has a base plate 13, which is essentially ring-shaped. The base plate 13 is disposed parallel to the upper cover plate 12. The base plate 13 and the upper cover plate 12 have essentially the same outer circumference, and when viewed in the direction of the axis of rotation 11 are aligned with one another. During operation, the base plate 13 is disposed between the cutting filament 7 and the ground 26. The base plate 13 is accordingly disposed on that side of the path 21 that faces away from the guide tube 5. The base plate 13 has a central opening 14 through which the cutting filament head 6 extends. Formed between the base plate 13 and the cutting filament head 6 is an annular space 28 that enables an unobstructed rotation of the cutting filament head 6 relative to the base plate 13. On that side facing the ground, the cutting filament head 6 is provided with an actuation cap 19 for an adjustment device of the cutting filament 7. By pressing the actuation cap 19, a prescribed length of the cutting filament 7 is released. Thus, the length of the cutting filament 7 can be adjusted by placing the actuation cap 19 upon the ground 26.

The guide tube 5 is inclined relative to the axis of rotation 11 by an angle of less than 90°. The guide tube 5 accordingly extends at an angle to the plane of the upper cover plate 12 of the guard 8. The guard 8 has a peripheral wall 18 which, in the region below the guide tube 5 and on both sides thereof, extends at the outer periphery of the path 21. However, the peripheral wall 18 does not extend over the entire periphery of the path 21. Rather, in the open area 9, the peripheral wall 18 is notched or cut out. In this region, the filament 7 extends out of the guard 8. The open area 9 extends over an angle α that is expediently at least 180° and in particular approximately 270°. In the open area 9, the cutting filament 7 projects beyond the guard 8 by a distance a, which is preferably from 5 to 25 mm. A good cutting efficiency results if the filament projection a is from about 8 to 10 mm.

Disposed at the open area 9 are two clamping elements 34 that connect the upper cover plate 12 to the base plate 13 and that increase the stability of the guard 8 at the open area 9.

Disposed in the guard 8 is a device 20 for cutting the cutting filament 7 to length. In the cross-sectional illustration of FIG. 4, the device 20, which is embodied as a blade for cutting the filament to length, is offset radially inwardly relative to the peripheral wall 18. The position of the blade for cutting the filament to length is preferably adjustable, so that the length of the cutting filament 7 can be adjusted. In the embodiment illustrated in FIG. 5, a device 32 for cutting the filament to length is provided that connects the upper cover plate 12 to the base plate 13. In the region of the cut-to-length device 32, no peripheral wall is provided between the upper cover plate 12 and the base plate 13. The device 32 for cutting the filament to length is embodied as a blade.

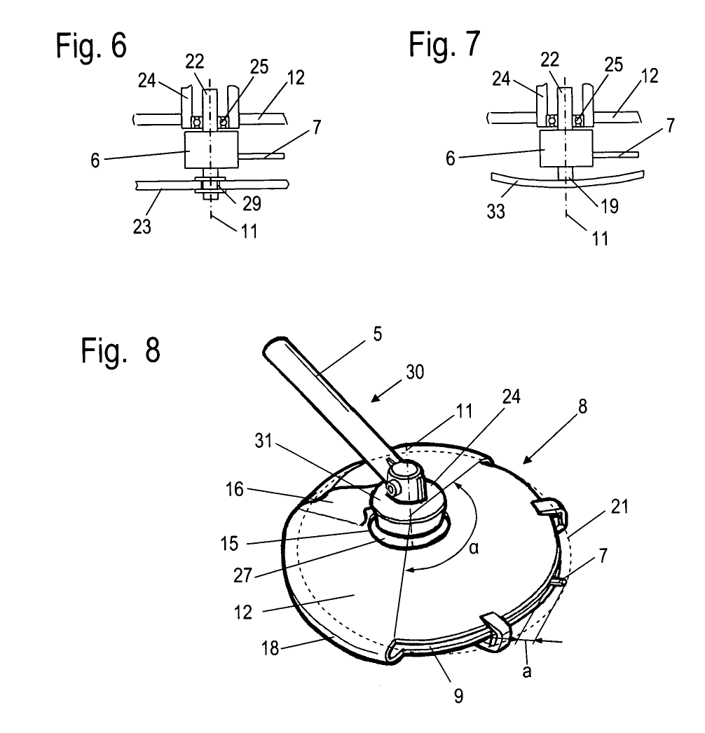

FIG. 6 shows another embodiment for the guard 8. The upper cover plate 12 is secured to the housing 24. However, as shown in FIG. 2, the upper cover plate 12 can also be secured to the guide tube 5. The cutting filament head 6 is disposed on a drive shaft 22, which is rotatably mounted in the housing 24 via a bearing 25. The drive shaft 22 is rotatably driven by the drive motor about the axis of rotation 11. A base plate 23 is disposed on that side of the cutting filament 7 that is opposite the upper cover plate 12. The base plate 23 is mounted on the drive shaft 22 of the cutting filament head 6. In this connection, the base plate 23 is rotatably supported relative to the drive shaft 2. A friction or sleeve bearing 29 is provided for this purpose. However, other structural configurations can also be advantageous. In the embodiment illustrated in FIG. 6, the guard 8 has a stationary upper cover plate 12 and a co-rotational base plate 23. As soon as the base plate 23 comes into contact with a fixed obstacle, it is slowed down or even stopped thereby and rotates relative to the drive shaft 22. A peripheral wall 18 can be formed either on the upper cover pate 12 or on the base plate 23. The base plate 23 can also be rotatably mounted on the cutting filament head 6. The cutting filament head 6 can then have an adjustment device for the cutting filament 7, whereby the adjustment device extends through the base plate 23.

The inventive guard ensures that the cutting filament 7 can come into contact with material that is to be cut only via a short end portion of its length. This provides a good protection while still providing a good cutting efficiency.

FIG. 7 shows an embodiment for the guard of a trimmer according to which the upper cover plate 12 is secured to the housing 24. The base plate 23 is flexible and is supported on the upper cover plate 12, for example by a peripheral wall which is not shown in FIG. 7. The base plate 33 rests against the actuation cap 19 of the actuation device for the adjustment of the cutting filament 7. The base plate 33 has no central opening. Due to the flexible nature of the base plate 33, when the guard bumps against the ground, the base plate 33 is deformed, and the actuation cap 19 is actuated, so that the cutting filament 7 is adjusted.

In the embodiment shown in FIG. 8, the holder or fastener 16 is secured to the housing 24, which forms the gear case 31. In other respects, this embodiment corresponds to that of FIGS. 2 and 3.

The specification incorporates by reference the disclosure of German priority document 10 2005 049 767.5 filed Oct. 18, 2005.

The present invention is, of course, in no way restricted to the specific disclosure of the specification and drawings, but also encompasses any modifications within the scope of the appended claims.

What I claim is:

1. A trimmer, comprising:
a cutting filament head, which is adapted to be rotatably driven by a drive motor, wherein a cutting filament is adapted to extend out of said cutting filament head, and wherein during a trimming operation said cutting filament defines a path; and
a guard, wherein in a trimming position of said trimmer a portion of said guard is adapted to be disposed between said path of said cutting filament and a ground surface.

2. A trimmer according to claim 1, wherein a large area of said path of said cutting filament is covered by said guard relative to a ground surface.

3. A trimmer according to claim 1, wherein that portion of said guard that during operation is disposed between said path of said cutting filament and a ground surface is embodied as a base plate.

4. A trimmer according to claim 3, wherein said base plate has a central opening through which said cutting filament head projects, wherein said cutting filament head is provided with an actuation device for effecting a post feeding of cutting filament, and wherein said actuating device extends through said central opening of said base plate.

5. A trimmer according to claim 3, wherein said base plate is flexible and is adapted to act upon an actuating device provided for a post feeding of cutting filament.

6. A brushcutter according to claim 3, wherein said base plate is mounted so as to be rotatable relative to said cutting filament head.

7. A trimmer according to claim 3, wherein a part of said guard is disposed on a side of said path of said cutting filament that during operation faces away from a ground surface.

8. A trimmer according to claim 7, wherein said part of said guard that during operation is disposed on the side of said path of said cutting filament that faces away from the ground surface is embodied as an upper cover plate.

9. A trimmer according to claim 8, which further comprises a housing in which the drive motor is disposed, and a guide tube, wherein said cutting filament head is disposed on an end of said guide tube that is remote from said housing, wherein said base plate is disposed on a side of said path of said cutting filament that is remote from said guide tube, and wherein said upper cover plate is supported on said guide tube or on a gear case of said trimmer.

10. A trimmer according to claim 3, wherein said guard is provided with a peripheral wall that covers a portion of the periphery of said path of said cutting filament.

11. A trimmer according to claim 10, wherein said peripheral wall connects said base plate with an upper cover plate.

12. A trimmer according to claim 1, wherein said guard has an open area along a periphery thereof at which said path of said cutting filament is not covered by said guard.

13. A trimmer according to claim 12, wherein in said open area of said guard said cutting filament projects beyond said guard by more than 5 mm and less than 25 mm.

14. A trimmer according to claim 13, wherein said projection of said cutting filament is approximately 10 mm.

15. A trimmer according to claim 12, wherein said open area of said guard extends over an angle (α) of at least 180°.

16. A trimmer according to claim 15, wherein said open area extends over an angle (α) of about 270°.

17. A trimmer according to claim 1, which further comprises a device for cutting said cutting filament to length.

18. A trimmer according to claim 17, wherein said device for cutting said cutting filament to length is disposed on an inner side of said guard. 19. A trimmer according to claim 17, wherein said device (32) for cutting said cutting filament to length connects a base plate with an upper cover plate.
